(19) United States
(12) Patent Application Publication
(10) Pub. No.: US 2020/0311700 A1
(43) Pub. Date: Oct. 1, 2020

(54) MOBILE PAYMENT SYSTEM WITH A USER-DEFINED VIRTUAL SIGNAL COMPRISING A ONE-TIME PASSWORD

(71) Applicant: BLUE POPCON CO.LTD, SEOUL (KR)

(72) Inventor: YOUNG MAN HWANG, GOYANG-SI (KR)

(21) Appl. No.: 16/364,131

(22) Filed: Mar. 25, 2019

(51) Int. Cl. G06Q 20/08; G06Q 20/20

(52) U.S. Cl. CPC G06Q 20/085; G06Q 20/206

(57) ABSTRACT

Methods and apparatus to generate a user-defined virtual signal to secure mobile payments are described. The apparatus can configure the features of the user-defined virtual signal to broadcast; generate a random string of numbers and characters forming the signal identity to broadcast; allow a user to determine the signal identification characters; allow the user to configure technical features of the transmitting signal; allow the user to determine the features of the transmitting signal to display on the device; display the configured feature of the signal to transmit to the user; and store the configured features of the generated signal into the memory, the signal transmitted to a receiver device.

### TECHNICAL FIELD

This disclosure relates to an improved security authentication system and method for mobile payment using an individual user-defined virtual beacon signals and external networks available to the user devices.

### BACKGROUND OF THE INVENTION

Physical beacon devices transmit Bluetooth Low Energy signals delivering their identifiers, such as identification numbers, spatial data packets. By taking advantage of the signal features, store retailers have used the beacons to find the customer's physical presence in the store. Then, through the customer's networks, the beacon devices drive and engage the customers nearby the store and gather feedback and pass valuable information. For example, in a Gap store, Gap application running on the customer mobile device can alert them of targeted information in the store as they walk past, displays contents downloaded from a server while they are in the store. As an alternative to standard beacon devices, virtual beacons, which is imaginary, can do the same or similar role as a real beacon transmitter. And the related industries expect that the number of virtual blue-tooth beacons increase to provide more accurate location of the customer user in real time.

However, broadcast-based beacon technology has been one-way communication. Most customer devices merely receive the beacons at given locations in a venue. However, given that personal mobile terminal can generate virtual beacon signal it would be helpful to secure the device user's mobile transaction. But what and how to apply a useful feature of the beacon for this purpose hasn't been developed.

### SUMMARY OF THE INVENTION

This invention discloses a method, system, and apparatus for authenticating mobile transactions by using a user-defined signal: the user-defined virtual beacon signal identifiers and contents the signal carries.

In one embodiment, a method for processing a mobile payment between a merchant and a customer user comprises: creating, by a user device, characteristics of a user-defined virtual signal; transmitting, by the user device, the user-defined virtual signal to the merchant device within a preset period defined in advance; storing, by the user device, the characteristics of the user-defined virtual signal; and sending, by the user device, the characteristics of the user-defined virtual signal to a payment gateway for further proceeding the mobile payment.

In another embodiment, the method further comprises allowing the user to determine an identity of the user-defined virtual signal comprising at least one of Universally Unique Identifier (UUID) and Uniform Resource Identifier (URI) of the signal to transmit. In another embodiment, the method further comprises generating, by the user device, random Universally Unique Identifier (UUID) or Uniform Resource Identifier (URI) of the user-defined virtual signal to transmit in response to the user's direction.

In another embodiment, the method further comprises allowing the user to configure the signal and to determine the characteristics of the signal to display on the user device. In another embodiment, the method further comprises displaying, by the user device, the signal characteristics configured by the user comprises at least one of i) Universally Unique Identifier (UUID) of the user-defined virtual signal; ii) Uniform Resource Identifier (URI) of the signal, iii) transmit power of the signal, iv) the signal transmission time, and v) expected range of the signal. In another embodiment, the method further comprises automatically changing, by the user device, Universally Unique Identifier (UUID) of the user-defined virtual signal each time when generating the signal.

In another embodiment, characters of the signal UUID are derived from at least one of i) an identifier of Point of Sale (POS) terminal of the merchant, ii) data associated with the POS payment processing that takes place between the user and the merchant, iii) data related to the product or service purchased in the POS processing, and iv) the processing ID number, date, time, value, and type of the processing, description of the product or server, discounted value relating to the processing. In another embodiment, the merchant device is further configured to relay the information of the user-defined virtual signal to the payment gateway for further payment proceeding via a network connecting the merchant device and the payment gateway. In another embodiment, the method further comprises determining, by the payment gateway, whether to allow the transaction involving with the mobile payment by comparing the features of the signal transmitted via the client device network and those of the signal sent via a merchant device network.

In some embodiment, a system for securing a mobile payment between a merchant and a customer, the system comprises one or more devices to: facilitate a mobile payment between the merchant and the customer; generate a user-defined virtual signal to transmit; allow a user to determine the signal identification characters; allow the user to configure technical features of the transmitting the user-defined virtual signal; allow the user to determine the characteristics of the transmitting the signal to display on the device; and transmit the signal to a corresponding device operated by either the merchant or the customer.

In another embodiment, the one or more devices are further to activate the generation of random characters of Universally Unique Identifier (UUID) of the user-defined virtual signal. In another embodiment, the UUID of the user-defined virtual signal is derived from at least one of i) the identification of Point of Sale (POS) terminal of the merchant, ii) data associated with the mobile payment that takes place between the customer and the merchant, iii) data related to the product or service purchased using the POS terminal, and iv) the payment transaction serial number, date, time, value, and type of the mobile transaction, description of the product or server, a discounted value related to the mobile transaction.

In another embodiment, the one or more devices are further to display to the user the signal information to alter at least one of i) Universally Unique Identifier (UUID) of the signal, ii) Uniform Resource Identifier of the signal, iii) identification numbers of the user-defined signal, iv) the signal strength, v) the signal transmission time, and vi) expected range of the signal. In another embodiment, the one or more devices are further to automatically change Universally Unique Identifier (UUID) of the signal with a new group of numbers and characters each time when transmitting the user-defined virtual signal.

In some embodiment, a non-transitory computer-readable medium storing instructions, the instruction comprises one or more instructions that make one or more processors to: configure the features of a user-defined virtual signal to broadcast; generate a random string of numbers and characters of the user-defined virtual signal identity to broadcast; allow the user to determine the signal identification characters; allow the user to configure technical features of the user-defined virtual signal; allow the user to determine the features of the user-defined signal to display on the user device; display the configured feature of the user-defined virtual signal on the user device; and store the configured features of the user-defined signal into the memory, the signal transmitted to a receiver device.

In another embodiment, the one or more instructions, when executed by the one or more processors, further cause the one or more processors to activate generation of a random string of numbers and characters to be a Universally Unique Identifier (UUID) of the user-defined virtual signal to transmit. In another embodiment, the one or more instructions, when executed by the one or more processors, further cause the one or more processors to create a Universally Unique Identifier (UUID) of a new user-defined virtual signal each time after broadcasting the user-defined signal. In another embodiment, the one or more instructions, when executed by the one or more processors, further cause the one or more processors to generate the UUID of the signal based on least one of i) the identification of a Point of Sale (POS) terminal relating to a mobile payment between a customer and a merchant, ii) data associated with the POS terminal, iii) data related to the product or service relating to the mobile payment, and iv) the mobile payment transaction number, date, time, value, type of the transaction, description of the product or server, and discounted value relating to the mobile payment.

In another embodiment, the one or more instructions, when executed by the one or more processors, further cause the one or more processors to display to the user-defined virtual signal information to alter at least one of i) Universally Unique Identifier (UUID) of the user-defined virtual signal, ii) the signal ID, iii) the signal identification numbers, iv) power level of the user-defined virtual signal, v) the duration time of the user-defined virtual signal, and vi) an expected range of the user-defined virtual signal.

### BRIEF DESCRIPTION OF THE DRAWINGS

FIG.1 shows exemplary components of a user equipment device, which can generate and display messages of a user-defined signal to broadcast according to one embodiment of the present invention;

FIG. 2 shows exemplary components of one or more devices according to the present invention;

FIG.3 is a diagram of a mobile payment using a user-defined virtual signal from a customer user device under one embodiment of the present invention;

FIG.4 is a diagram of a mobile payment using a user-defined virtual signal coming from a retailer device terminal under one embodiment of the present invention;

FIG. 5 shows a touch-screen interface for configuring a user-defined virtual beacon signal on a user mobile device under one embodiment of the present invention.;

FIG. 6 shows a touch-screen interface for configuring a user-defined virtual beacon signal on a user mobile device according to another embodiment of the present invention;

FIG. 7 is the sequential diagram about a mobile payment processing using a user-defined virtual signal from a customer user device under one embodiment of the present invention;

FIG. 8 is an exemplary screen of a merchant terminal displaying the details of a mobile payment transaction under one embodiment of the present invention; and

FIG. 9 is a diagram showing a user-defined virtual signal enabling a mobile payment transaction under one embodiment of the present invention.

### DETAILED DESCRIPTION OF THE INVENTION

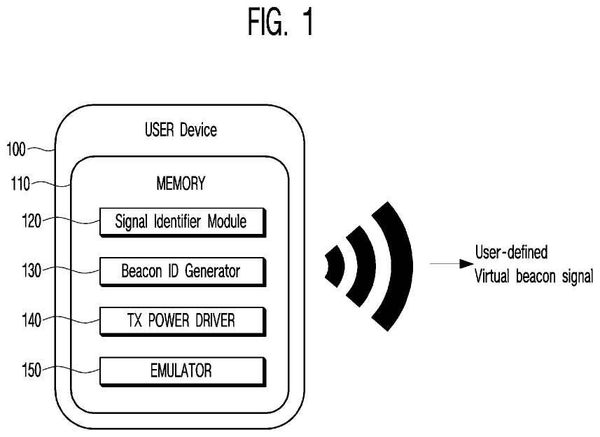

FIG.1 shows exemplary components of a user equipment device, which can generate and display messages of a user-defined signal to broadcast according to one embodiment of the present invention. More precisely, it shows the components generating a user-defined virtual beacon signal to broadcast.

In one embodiment, a user device 100 may be a mobile device while, in other embodiments, the device 100 may be located in a user mobile device and generate a user-defined virtual beacon signal. The user device 100 may include an input device, e.g., keyboard, I/O interface for coupling the input device and an output device which may be a display, to a bus which connects these components to the other parts of the server including memory, processor and network interface. Even if not depicted in Fig.1, the memory 110 may include control modules to broadcast the user-defined virtual beacon signal. The control module can receive the user's inputs to define the signal to transmit, or it can randomly generate a unique signal identifier(s) to broadcast. In other embodiments, the memory 110 may store the signal identifiers or its special characters either the user has defined, or the device has generated.

In one embodiment, a signal identifier module 120 may store a virtual beacon signal details to broadcast or details of a virtual beacon signal transmitted. And the details are about all characteristics of the virtual signal generated, such as signal identifiers, the signal transmitting power level, the signal transmitted location, the signal strength.

A beacon ID generator 130 may generate a new randomized sequence of characters of a one-time universally unique identifier (UUID) or one-time Universal Resource Identifier (URI) or URL to broadcast. When a user of the device 100 chose not to define the signal Id directly, then the ID generator 120 may generate a random UUID of the virtual signal to broadcast. A signal transmission power driver 140 can manage the strength of the virtual signal the device 100 generates during the time it is transmitting.

An emulator 150 may run the signal identifier settings, which allows the device users to define the signal identifiers by entering or changing the signal virtual beacon identifiers: UUID, a transmitting power level, the signal frequency band, the signal transmitting period, a user-defined password, or the signal transmitting ranges. In another embodiment, the emulator 150 may generate the virtual signal identifiers by itself as instructed by the user. In one embodiment, the emulator 150 is one sub-processor module to execute programs for creating the particular signal identifiers by interacting with the user's inputs entered. In another embodiment, the emulator 150 may run a notification setting in the user mobile terminal, which allows the user to determine the contents of the signal identifiers to display in the user device. The virtual signal content may include at least one of i) Universally Unique Identifier (UUID) of the signal, ii) Uniform Resource Identifier of the signal, iii) identification numbers of the user-defined signal, iv) the signal strength, v) the signal transmission time, and vi) expected range of the signal.

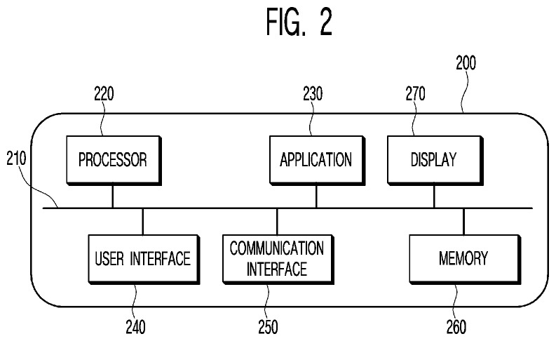

FIG. 2 shows components of one or more devices according to the present invention. Those components may be embedded into a customer user mobile device or a Point of Sale terminal (POS) device operating by a shop merchant. Device 200 may include a bus 210, processor 220, application 230, a user interface 240, a communication interface 250, memory 260, and display 270. Bus 210 may include a component for communication among the components of device 200.

Processor 220 is implemented in hardware, firmware, or a combination of hardware and software. Processor 220 may include at least one of: (i) a central processing unit (CPU), (ii) a graphics processing unit (GPU), (iii) an accelerated processing unit (APU), (iv) a microprocessor, and/or any processing component (e.g., a field-programmable gate array (FPGA), (v) an application-specific integrated circuit (ASIC) that interprets and/or executes instructions. Processor 220 may execute software instructions stored in a computer-readable medium, such as memory 260.

In one embodiment, processor 220 may run the entire steps for creating and broadcasting signal identifiers of a user-defined virtual beacon signal. Processor 220 may further interact with a device user for configuring a virtual signal to transmit. Processor 220 may also notify the transmitting status of the signal to the user. Processor 220 may also be configured to apply the user-defined virtual signal operations for implementing a mobile payment. For example, processor 220 may run the signal configuration settings and present signal identifiers on display 270. As a result of this operation, a user can manually define which particular virtual signal is to be transmitted and how to deliver the signal, such as (1) how long the signal will last, (2) how strongly the signal will be transmitted to a receiving terminal device, (3) the frequency ranges the signal would be operated.

Regarding the signal character to deliver, processor 220 may enable the user to enter the signal ID characters, such as Universally Unique Identifier (UUID) and Uniform Resource Identifier (URI) of the virtual beacon signal using the user interface 240. Processor 220 may also run beacon ID generator 130 for generating a random password to transmit, awaiting the user's approval to transmit it. Processor 220 may allow the user to configure the virtual beacon signal characters. And the signal characteristics may comprise at least one of i) Universally Unique Identifier (UUID) of the user-defined virtual signal, ii) Uniform Resource Identifier (URI) of the signal, iii) transmit power of the signal, iv) the signal transmission time, and v) an expected range of the signal.

Responding to the user inputs on a user interface 240, processor 220 may generate random Universally Unique Identifier (UUID) or Uniform Resource Identifier (URI) of the virtual signal to transmit. Processor 220 may also retrieve an old URI or old characters of the signal and assign those data to a virtual signal to broadcast. Processor 220 may also automatically change a Universally Unique Identifier (UUID) of the user-defined virtual signal each time when generating the signal.

Processor 220 may determine the signal features to deliver and the features to be shown to the user on display 270. More precisely, processor 220 may display the signal characteristics, as previously set, while broadcasting it to a receiving terminal device. In one embodiment, once having transmitted the signal, processor 220 may then store the signal characters in memory 260, then send them to other terminal devices to via Wi-Fi or other available internet works. In another embodiment, processor 220 may also run the signal notification settings and display the signal notification setting, which allows the users to determine the signal features to notify the user when being broadcasted.

For conducting a mobile payment transaction between a customer user and merchant user, the processor 220 may create UUID of a user-defined beacon signal based on data about at least one of i) an identifier of Point of Sale (POS) terminal of the merchant, ii) data associated with the POS payment processing that takes place between the user and the merchant, iii) data related to the product or service purchased in the POS processing, a nd iv) the processing ID number, date, time, value, and type of the processing, description of the product or server, discounted value relating to the processing.

When a merchant user runs the device 200 for a mobile payment with a customer user, the processor 220 may be configured to relay the information of the user-defined virtual signal coming from the customer user to the payment gateway for further payment proceeding via a network connecting the merchant device and the payment gateway.

Application 230 may include application software designed to run on a mobile payment in connection with a mobile wallet that stored a customer-user credit card details so that the user pays for the purchased item digitally. A device user can download a mobile wallet app on the device and add credit or debit card information that will be stored in memory securely.

User interface 240 may include a component to receive information, such as via user input (e.g., a touch screen display, a keyboard, a keypad, a mouse, a button, a switch, a microphone.). The user interface may include a sensor for sensing information (e.g., a global positioning system (GPS) component, an accelerometer, a gyroscope, an actuator, etc.). The user interface 250 may provide output information from device 200 (e.g., a display, a speaker, one or more light-emitting diodes (LEDs), etc.).

Communication interface 250 may include a transceiver-like component (e.g., a transceiver, a separate receiver, and transmitter, etc.) that enables the device 200 to communicate with other devices, such as via a wired connection, a wireless connection, or a combination of wired and wireless connections. Communication interface 260 may receive information from another device or provide information to another device. For example, communication interface 250 may include an Ethernet interface, an optical interface, a coaxial interface, an infrared interface, a radio frequency (RF) interface, a universal serial bus (USB) interface, a Wi-Fi interface, a cellular network interface, or the like.

The non-transitory computer-readable medium (memory) 260 may include memory space within a single physical storage device or memory space spread across multiple physical storage devices. Software instructions may be read into memory 260 from another computer-readable medium via communication interface 250. In one embodiment, memory 260 storing relevant instructions, when executed by the one or more processors, instructs the one or more processors 220 to activate generation of a random series of numbers and characters to form UUID or URI of the one-time virtual beacon signal to transmit.

In another embodiment, memory 260 may further cause the one or more processors 220 to generate UUID or URI of the one-time virtual beacon signal based on least one of i) the identification of Point of Sale (POS) terminal of the merchant, ii) data associated with the POS transaction that takes places between the user and the merchant, iii) data related to the product or service purchased in the POS transaction, and iv) a transaction number, date, time, value, type of the transaction, description of the product or server, and discounted value related to the transaction. Further, memory 260 storing instructions, when executed by the one or more processors, also run the one or more processors 220 to randomly generate the signal UUID for each time after completing the signal transmission.

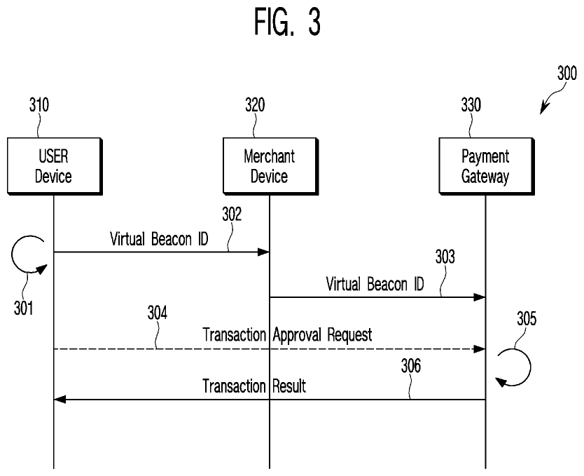

FIG. 3 is a diagram of an exemplary implementation of mobile payment using a user-defined virtual signal from a user device under one embodiment of the present invention. The diagram comprises a user device 310, a merchant device 320, and a payment gateway 330. More precisely, it explains how the virtual beacon signal from a customer user device interacts with its corresponding device for securing his or her mobile payment.

User device 310 may be a mobile device, a tablet computer or other mobile computing device capable of being, and contains a virtual beacon transceiver and a wallet application described. The wallet application is a software application which allows a customer user to start and complete mobile payment using previously stored or newly entered payment account information and may contain additional capabilities such as the provision and management of receipts, coupons, discount offers, and so forth.

Merchant device 320 may be a Point of Sale Terminal (POS terminal). While, in other embodiments, merchant device 320 may be embodied into a POS terminal capable of generating its virtual beacon signal. Merchant device 320 may include an input device, e.g., a keyboard, I/O interface for coupling the input device and an output device which may be a display, to a bus which connects the components to the other parts of the server including a memory, processor and network interface. The merchant network may be internet networks or a private network connecting the merchant device 320 and payment gateway 330. Merchant device 320 may include security measures controlling user access to and interaction with, including password, personal identification number (PIN) or various bio-metric applications. Also, a person working at the retail store may manually enter the item information into merchant device 320.

Payment gateway 330 is an e-commerce service that processes credit card payments for online and traditional brick and mortar stores. Payment gateways 330 facilitates these transactions by transferring essential information between web-enabled mobile devices/websites and the front- end processor/bank. Payment gateway 330 fulfills a vital role in the e-commerce transaction process, allowing the payment between merchant device 320 and customer device 310. Popular payment gateways may include PayPal/Braintree, Stripe, and Square. More particularly, payment gateway 330 can facilitate the one-time virtual beacon-based mobile transaction.

Payment gateway 330 is accessible to a user device 310 via Wi-Fi or other internet networks. The customer network includes, for example, an internet communication between a user device 310 and the payment gateway 330, as facilitated by a cellular network, or may include any local network to deliver information between the user device 310 and the payment gateway 330. Payment gateway 330 is also connected to the merchant device over the merchant network to perform functions appropriate for authorizing the credit card the user selected or direct payments for commercial transactions conducted electronically on the internet.

For an exemplary operation, assume that a customer user and merchant, both have agreed on the details of the purchasing and the use of the mobile payment, which is to be secured by the customer-defined virtual beacon signal. Besides, the user is already allowed to use digital wallets or mobile wallets finishing digital card enrollment process with related internet servers, financial institutions (Bank), and payment networks.

The operations under diagram 300 may begin with the customer logging into user device 310 for a mobile payment. A private network access request for accessing payment account may be initiated at the operation of user device 310. Before proceeding to operation 301, the customer user is presented with the total price for the purchasing items and tells a cashier (merchant) that he or she wants to pay with a mobile phone. For example, the user may initiate a banking application running on user device 310 to pay for the items.

At operation 301, user device 310 may generate UUID or URI of a one-time virtual beacon signal to broadcast, as an identification code for the transaction. In other embodiments, the user can manually enter inputs about UUID or URI. Also, in other embodiments, the user may set the details of signal characters to transmit—signal strength, signal duration, and user-defined password—before broadcasting via Bluetooth Low Energy. At operation 302, user device 310 may transmit the virtual signal the user has configured, including the virtual beacon ID. At operation 303, the merchant device 320 relays the signal information to the payment gateway 330. Also, merchant device 320 delivers the detail of mobile payment and the signal information from user device 310 to payment gateway 330 on a private merchant's network.

At operation 304, the user device 310 transmits the virtual signal information, which was previously sent to the merchant device 320 at operation 302, to the payment gateway 330 via Wi-Fi or the Internet network between the user device 310 and payment gateway 330. At operation 305, payment gateway 330 decides whether the signal information from user device 310 is identical with the signal from merchant device 320. At operation 306, based on the virtual signal-based authentication on the customer's identity, the payment gateway 330 decide whether to authorize the request from user device 310. If approved, the payment gateway 330 may send a transaction approval on the payment to user device 310 via Wi-Fi or Internet network connecting user device 310.

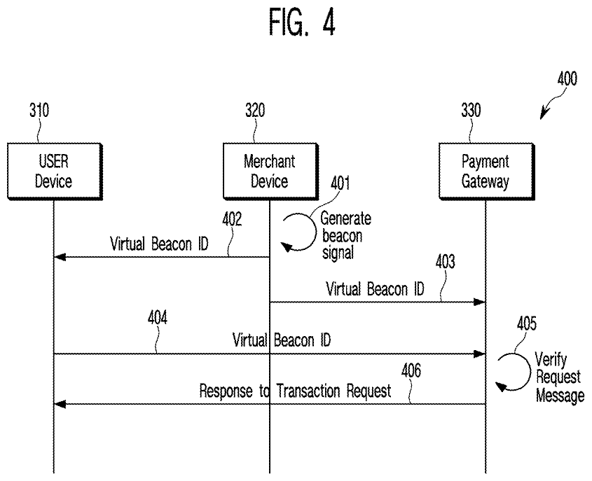

FIG. 4 is a diagram of an exemplary implementation of mobile payment using a user-defined virtual signal coming from a merchant device terminal under one embodiment of the present invention. For an exemplary operation, assume that a customer user and merchant have agreed on purchasing items the user has selected, that user would pay using mobile payment with digital wallets for the items, and that the merchant-defined virtual beacon signal would apply to secure the payment. The customer is already allowed to use digital wallets or mobile wallets finishing digital card enrollment process with related internet servers, financial institutions (Bank), and payment networks. The details of the technical features of a user device 310, a merchant device 320, and a payment gateway 330 are the same as described in FIG.3.

Before proceeding to operation 401, a merchant cashier may present a customer user with the total price for the purchasing items, as well as the details of the transaction. The user tells a cashier he or she wants to pay it with his or her mobile phone. For example, the user may start a banking application running on the device 310.

At operation 401, once finding that customer device 310 can receive a virtual beacon signal from a merchant device 320, merchant device 320 may generate the signal containing at least one of signal identifiers: a signal ID, signal power, signal frequency band, and so on. In one embodiment, a merchant device 320 may generate UUID or URI of a one-time virtual beacon signal to broadcast, as an identification code for the transaction. Merchant device 320 may randomly generate the signal identifier. But in other embodiments, the cashier (merchant) may enter inputs of the signal identifiers. Also, in other embodiments, the merchant may set the technical features of the transmitting signal using the merchant device 320—signal strength, signal duration, and user-defined password- before sending it to the user device 310 via Bluetooth Low Energy.

At operation 402, the merchant device 320 may transmit the signal to the customer device 310. The signal is to be transmitted only for the time period set by the merchant. At operation 403, merchant device 320 may then transmit the identical signal (identifiers) to the payment gateway 330. At operation 404, the user device 310 may relay the details of signal information sent from the merchant device 320 to the payment gateway 330 via Wi-Fi or the Internet network available to the user device 310. And, the user device 310 may transmit the request for the approval of the transaction.

At operation 405, payment gateway 330 verifies whether the details of the two signals-one from user device 310 and the other from the merchant device 320—are identical for proceeding for approval of the payment request. At operation 406, based on the identification of the signals, payment gateway 330 may transmit confirming or disconfirming message to user device 310 via Wi-Fi or the Internet network available to user device 310.

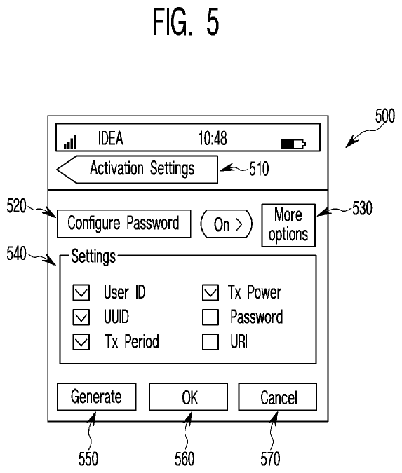

FIG. 5 shows a touch-screen interface for configuring a user-defined virtual beacon signal on a user mobile device under one embodiment of the present invention. In one embodiment, touch screen interface 500 can be a display 270 of device 200.

Touch-screen interface 500 may enable Processor 220 to interact with a device user 200. Touch-screen interface 500 is configured to receive a device user input for defining the virtual signal details. “Activation Setting” icon 510 shows the details of the signal to configure for the user and enable the user to define them. By dragging the “Activation Setting” icon 510, the user may return to previous screen. “Configure Password” icon 520 may be activated by toggling “On.” Processor 220 may then allow the user to configure the signal details. Below “Settings” icon 540, the signal details are arranged in a rectangular layout on the touch screen interface 500. Here, “User ID,” “UUID,” “Tx Period,” and “Tx Power” are checked. But the “Password” and “URL” items are not checked.

Based on those settings, “Generate” button 550 may produce the corresponding virtual signal details to transmit. The generated signal details may be the same as the signal previously transmitted. But the signal UUID would be new random characters, being effective only for one broadcasting session. Processor 220 also may open the next screen showing the details of the signal produced to transmit. In the same way, the boxes of “Password” and “URI” may generate a user-defined URL address and password previously stored in memory 260. In another embodiment, the generated signal characters using touch screen interface 600 may be the same as the signal previously transmitted when none of the items under “Profile Configuration” is selected. But, the signal UUID generated per each signal transmitting may be the new random characters effective only one broadcasting session regardless of the user's entering inputs.

“More Options” button 530 may allow the user to enter the data about the signal profiles into the device 200. For example, the “More Options” icon 530 may allow the user to enter inputs to define “UUID” or “URI.” Also, “More Options” button 530 may allow the user to directly define the marked signal profiles below “Settings” 540. “More options” button 530 may also allow the user to add more signal profile item or remove the signal profile presented on touch-screen interface 500. In the same way, the user may configure the signal details to transmit or reset the previously defined details of the signal. The signal characters can be the signal transmission time, the signal power level, and the user ID contained in the signal to transmit. Also, in one embodiment, “OK” button 560 may open the next screen showing the list of details for the configured virtual signal. “Cancel” button 570 may allow the user to enter and or re-enter the signal identifiers to broadcast.

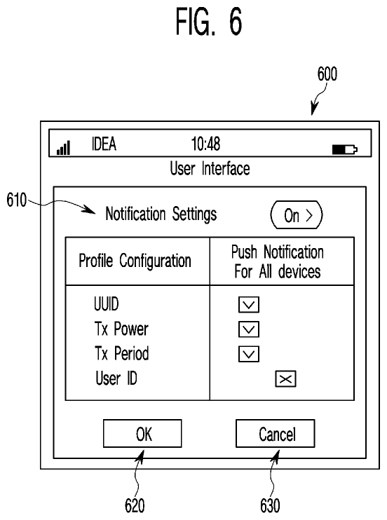

FIG. 6 shows a touch-screen interface for configuring user-defined virtual beacon signal settings on a mobile user device under another embodiment of the present invention. In one embodiment, touch screen interface 600 can be a display 270 of device 200. Processor 220 may interact with a device user 200 via the touch interface 600. Touch screen interface 600 may receive the user inputs for the signal profile to transmit. Touch screen interface 600 may be further configured to notify the signal profile to the device user.

“Notification Settings” icon 610 may receive user inputs. Responding to the user's input, processor 220 may configure details of a virtual beacon signal to transmit and shows the transmitting signal characters. When the “Notification Settings” is turn on, the user may select the items to configure, listed under “Profile Configuration.” Processor 220 may then present the screen about the signal profiles while the signal is transmitting. Below “Notification Settings” icon 610, the details of the signal to broadcast are presented. For illustrative purposes, check boxes of “UUID,” “Tx Period,” “Tx Power” are marked and the check boxes of “User ID” is not checked. Given this signal configuration, when pushing the “OK” button, the use may be able to see the details to the signal transmitting.

“Cancel” button may allow the user to enter and or reset signal details previously set. Also, in one embodiment, when clicking “OK” button 620, the processor 220 may generate the configured virtual signal, containing newly created signal UUID and other characters previously stored in memory 260. Further, the processor may open the next screen showing the details for configured virtual signal transmitting. By clicking the “Cancel” button 570, the processor 220 may allow the user to enter and or re-enter the signal identifiers to broadcast.

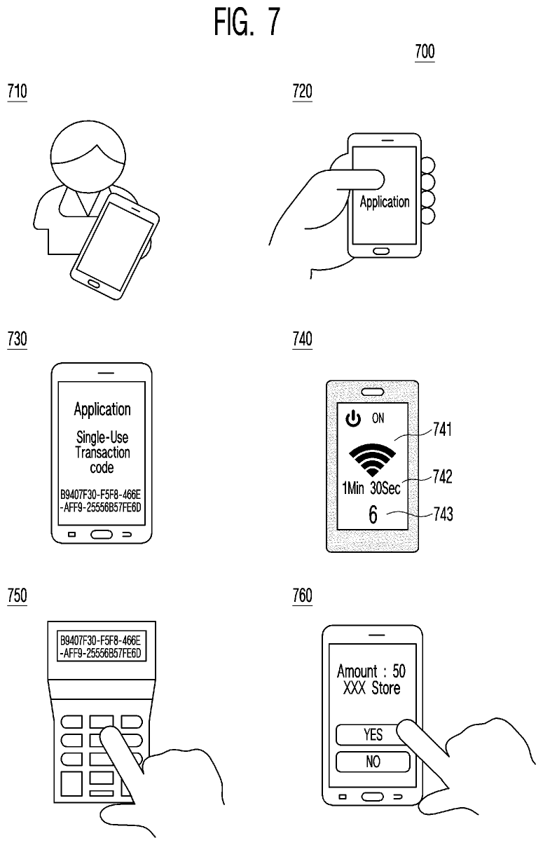

FIG. 7 is a sequential diagram about a mobile payment process using a user-defined virtual signal from a customer user device under one embodiment of the present invention.

At operation 710, a merchant cashier presents a customer with the total price for the sales item(s). The customer tells the cashier he or she wants to pay it using a mobile phone. At operation 720, the customer activates a banking application running on the mobile terminal. At operation 730, the customer reads a virtual signal UUID, which was randomly generated to authenticate the mobile payment. The processor 220 in device 100 may generate the signal UUID, but in other embodiments, the customer may manually input the UUID using the customer interface 240.

At operation 740, the customer can read three characters of the transmitting signal—signal strength, signal duration, and customer-defined password on the mobile display 270. The radar icon 741 shows the broadcasting signal, the four bars of the image showing the signal strength. The message “1 Min 30 Sec” 742 indicates the signal transmission time. The symbol “6” 743 on the screen shows a password the customer has entered using the user interface 240. In other embodiments, the processor 220 may generate the password. And this signal transmits to the merchant device 320 running by the cashier via Bluetooth Low Energy.

At operation 750, the cashier using a merchant device 320 may read the identifier-UUID-transmitted and the other signal features transmitted. Then, the merchant device 320 may relay those signal features to the payment gateway 330. The signal identifier, i.e., the customer password “6,” does not appear on the merchant device screen. In other embodiments, the cashier may manually input the customer password to the merchant device after being told by the customer. The payment gateway 330 decides on whether the virtual signals from the user device 310 and the merchant device 320 are identical to each other. If the two signals are same, at operation 760, the customer device 310 may receive a confirmation on the payment sent from payment gateway 330 via Wi-Fi or Internet networks linked.

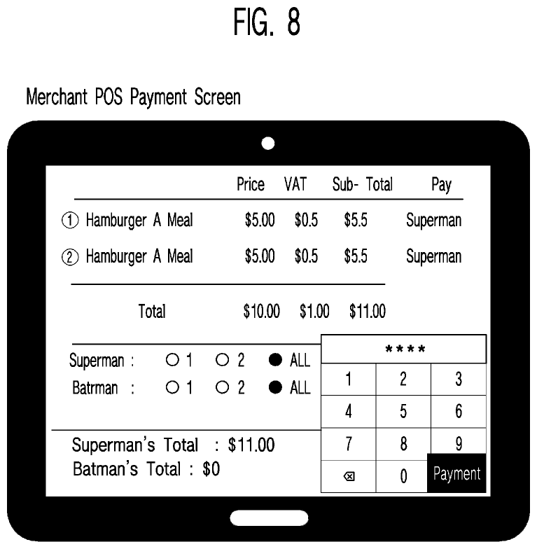

FIG. 8 is an exemplary screen of a merchant terminal displaying the details of the sales transaction in one embodiment of the present invention. The merchant terminal device may generate the purchase order, indicating types, quantities, and agreed prices for products or services. Merchant POS Payment screen, run by a merchant cashier for this payment transaction, may be able to pull up the purchase order, make any adjustments, and send the transaction details to the customer. In one embodiment, after receiving a customized virtual beacon signal from the customer device 310, the terminal device (the merchant POS terminal) may relay it to the payment gateway 330.

The terminal device is further configured not to reveal the customer's password transmitted to a cashier operating the merchant POS terminal. For instance, four digits password transmitted is hidden under asterisks or dots on the Merchant POS Payment Screen. Also, when the cashier enters the customer's password under the customer's direction, the screen hides the customer's password behind asterisks or bullets to prevent anyone nearby from stealing it.

In another embodiment, even if not shown on Fig.8, the merchant POS terminal may be configured to generate the cashier merchant-defined virtual beacon signal to broadcast. The POS terminal may generate random characters of the cashier-defined virtual signal identity to broadcast. The Merchant POS system screen is configured to allow the cashier to set the cashier-defined virtual signal. The merchant POS terminal may be further configured to generate the virtual beacon signal UUID based on at least data about of i) an identifier of Point of Sale (POS) terminal of the merchant, ii) data associated with the POS payment processing that takes place between the customer and the merchant, iii) data related to the product or service purchased in the POS processing, and iv) the processing ID number, date, time, value, and type of the processing, description of the product or server, discounted value relating to the processing. Further, the POS screen may be configured to display the feature of the cashier-defined virtual signal to transmit, in the similar way as shown at step 740 in FIG. 7.

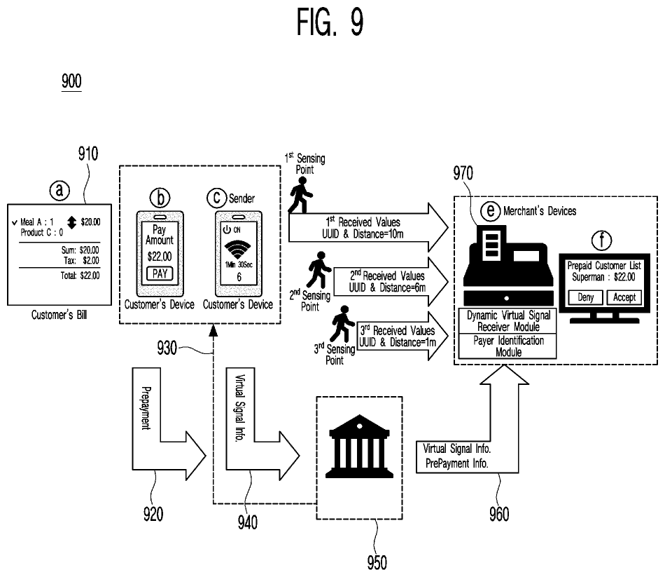

FIG. 9 is a diagram showing a user-defined virtual signal enabling a mobile payment transaction under one embodiment of the present invention. More particularly, it describes the method for submitting a pre-approval from the payment gateway 950 to a merchant POS 970. For the purpose of an exemplary operation, assume that a customer and merchant agreed on the relevant details of the purchase both parties made. The customer has allowed using digital wallets or mobile wallets finishing digital card enrollment process with related internet servers, financial institutions (Bank), and payment networks. The customer and merchant agreed that one-time virtual signal transmitted from the customer's device would be used to secure the mobile payment. Further, the customer has already authorized to use digital wallets or mobile wallets finishing digital card enrollment process with related internet servers, financial institutions (Bank), and payment networks.

At operation 910, the customer is presented with the total price for the purchasing items and informs a cashier about the use of the mobile payment, e.g., “I do like to pay with mobile wallet secured using virtual signal.” At operation 920, the customer pays the bill using the selected credit card retrieved by a wallet software application stored in the customer's mobile terminal and sends a purchase request to a payment gateway 950 via the customer's network. Further, the details of the card selected may be sent to the payment gateway 950 along with the merchant(seller) identification numbers so that the payment gateway 950 can promptly communicate with the merchant POS terminal 970.

At operation 930, once the bank communities and the payment networks respectively connected to the customer's device and the merchant device authorize the requested transaction, the payment gateway 950 will send the notification to the customer's device via the customer's network. At operation 940, when receiving the payment approval, the customer configures the one-time virtual beacon signal settings, as discussed in Fig.5, and transmits the details of the virtual signal to the payment gateway 950 via the customer's internet network.

At operation 950, the payment gateway 950 decides whether the device generating the virtual beacon signal is identical with the device that has initiated the request for transaction approval. At operation 960, if the customer's device is correctly identified, the payment gateway 950 relays the details of the signal transmitted and the mobile transaction to the merchant device 970 via the private network between the payment gateway 950 and the merchant device 950 (e.g. POS terminal device).

The merchant device 970 stores the details of the sales transaction and the beacon signal profiles sent from the payment gateway 970. This stored information may be used to identify the right customer among the customers claiming the mobile payment in the merchant store. In one embodiment, the merchant device 970 can reference the UUID numbers and varying strength of the virtual signal transmitted from the customer's device in the store in finding the right customer. After the identification of the customer is made, the POS software of the merchant closes th e receipt and print out the confirmation of payment. At operation 970, the cashier at a register (POS) ensured that the mobile payment 950 for the transaction was completed will assist the customer who presented him or her with the bill received to leave the merchant place.

What is claimed is:

1. A method for processing a mobile payment between a merchant and a customer user, the method comprising:
creating, by a user device, characteristics of a user-defined virtual signal;
transmitting, by the user device, the user-defined virtual signal to the merchant device within a preset period defined in advance;
storing, by the user device, the characteristics of the user-defined virtual signal; and
sending, by the user device, the characteristics of the user-defined virtual signal to a payment gateway for further proceeding the mobile payment.

2. The method claim 1, further comprising:
allowing the user to determine an identity of the user-defined virtual signal comprising at least one of Universally Unique Identifier (UUID) and Uniform Resource Identifier (URI) of the signal to transmit.

3. The method claim 1, further comprising:
generating, by the user device, random Universally Unique Identifier (UUID) or Uniform Resource Identifier (URI) of the user-defined virtual signal to transmit in response to the user's direction.

4. The method claim 1, further comprising:
allowing the user to configure the signal and to determine the characteristics of the signal to display on the user device.

5. The method claim 4, further comprising:
displaying, by the user device, the signal characteristics configured by the user comprising at least one of i) Universally Unique Identifier (UUID) of the user-defined virtual signal;, ii) Uniform Resource Identifier (URI) of the signal, iii) transmit power of the signal, iv) the signal transmission time, and v) expected range of the signal.

6. The method claim 1, further comprising:
automatically changing, by the user device, Universally Unique Identifier (UUID) of the user-defined virtual signal each time when generating the signal.

7. The method claim 6, wherein characters of the signal UUID are derived from at least one of i) an identifier of Point of Sale (POS) terminal of the merchant, ii) data associated with the POS payment processing that takes place between the user and the merchant, iii) data related to the product or service purchased in the POS processing, and iv) the processing ID number, date, time, value, and type of the processing, description of the product or server, discounted value relating to the processing.

8. The method claim 1, the merchant device is further configured to:
relay the information of the user-defined virtual signal to the payment gateway for further payment proceeding via a network connecting the merchant device and the payment gateway.

9. The method claim 1, further comprising:
determining, by the payment gateway, whether to allow the transaction involving with the mobile payment by comparing the features of the signal transmitted via the client device network and those of the signal sent via a merchant device network.

10. A system for securing a mobile payment between a merchant and a customer, the system comprising:
one or more devices to:
facilitate a mobile payment between the merchant and the customer;
generate a user-defined virtual signal to transmit;
allow a user to determine the signal identification characters;
allow the user to configure technical features of the transmitting the user-defined virtual signal;
allow the user to determine the characteristics of the transmitting the signal to display on the device; and
transmit the signal to a corresponding device operated by either the merchant or the customer.

11. The system claim 10, where the one or more devices are further to activate generation of random characters of Universally Unique Identifier (UUID) of the user-defined virtual signal.

12. The system claim 11, wherein the UUID of the user-defined virtual signal is derived from at least one of i) the identification of Point of Sale (POS) terminal of the merchant, ii) data associated with the mobile payment that takes place between the customer and the merchant, iii) data related to the product or service purchased using the POS terminal, and iv) the payment transaction serial number, date, time, value, and type of the mobile transaction, description of the product or server, a discounted value related to the mobile transaction.

13. The system claim 10, where the one or more devices are further to display to the user the signal information to alter at least one of i) Universally Unique Identifier (UUID) of the signal, ii) Uniform Resource Identifier of the signal, iii) identification numbers of the user-defined signal, iv) the signal strength, v) the signal transmission time, and vi) expected range of the signal.

14. The system claim 10, where the one or more devices are further to automatically change Universally Unique Identifier (UUID) of the signal with a new group of numbers and characters each time when transmitting the user-defined virtual signal.

15. A non-transitory computer-readable medium storing instructions, the instruction comprising:
one or more instructions that make one or more processors to:
configure the features of a user-defined virtual signal to broadcast;
generate a random string of numbers and characters of the user-defined virtual signal identity to broadcast;
allow the user to determine the signal identification characters;
allow the user to configure technical features of the user-defined virtual signal;
allow the user to determine the features of the user-defined signal to display on the user device;
display the configured feature of the user-defined virtual signal on the user device; and
store the configured features of the user-defined signal into the memory, the signal transmitted to a receiver device.

16. The non-transitory computer-readable medium storing instructions of claim 15, where the one or more instructions, when executed by the one or more processors, further cause the one or more processors to activate generation of a random string of numbers and characters to be a Universally Unique Identifier (UUID) of the user-defined virtual signal to transmit.

17. The non-transitory computer-readable medium storing instructions of claim 16,
where the one or more instructions, when executed by the one or more processors, further cause the one or more processors to create a Universally Unique Identifier (UUID) of a new user-defined virtual signal each time after broadcasting the user-defined signal.

18. The non-transitory computer-readable medium storing instructions of claim 16,
where the one or more instructions, when executed by the one or more processors, further cause the one or more processors to generate the UUID of the signal based on least one of i) the identification of a Point of Sale (POS) terminal relating to a mobile payment between a customer and a merchant, ii) data associated with the POS terminal, iii) data related to the product or service relating to the mobile payment, and iv) the mobile payment transaction number, date, time, value, type of the transaction, description of the product or server, and discounted value relating to the mobile payment.

19. The non-transitory computer-readable medium storing instructions of claim 15,
where the one or more instructions, when executed by the one or more processors, further cause the one or more processors to display to the user-defined virtual signal information to alter at least one of i) Universally Unique Identifier (UUID) of the user-defined virtual signal, ii) the signal ID, iii) the signal identification numbers, iv) power level of the user-defined virtual signal, v) the duration time of the user-defined virtual signal, and vi) an expected range of the user-defined virtual signal.
